(19) United States
(12) Patent Application Publication
(10) Pub. No.: US 2026/0220994 A1
(43) Pub. Date: Jul. 30, 2026

(54) METHOD AND APPARATUS FOR ENTITLEMENT

(71) Applicant: DISNEY ENTERPRISES, INC., Burbank, CA (US)

(72) Inventors: Jessica Lauren Harned, Orlando, FL (US); Vincent J. Sarlo, Orlando, FL (US); Rebecca Lyn Lake Pool, Orlando, FL (US)

(21) Appl. No.: 19/041,528

(22) Filed: Jan. 30, 2025

(51) Int. Cl. G07F 9/00; G07F 17/00

(52) U.S. Cl. CPC G07F 9/006; G07F 17/0042

(57) ABSTRACT

A vending device for associating an entitlement device with a user profile includes a security mechanism configured to secure the entitlement device; a processing element configured to receive a user input including authentication information; determine the user profile based on the authentication information, and associate the entitlement device with the user profile; and a dispensing portion configured to provide the entitlement device.

### BACKGROUND

Electronic entitlement devices such as fobs, wristbands, etc. are increasingly used to provide user access to venues, entertainment experiences, secure locations (e.g., offices), and the like. Entitlement devices can also be used to complete transactions. To provide such access, an entitlement device is associated with a profile for a certain user. As the entitlement device is scanned, read, sensed, or otherwise in communication with an access system, the access system identifies the user based on the association of the user to the entitlement device. The access system can then provide or deny access or features to the user according to the user profile.

However, providing, maintaining, and updating such associations between user profiles and entitlement devices is cumbersome, labor intensive, and does not provide a full lifecycle for entitlement devices after the user is finished using the entitlement device. Improved systems and methods to provide and manage entitlement devices are needed.

### BRIEF SUMMARY

In one embodiment, a vending device for associating an entitlement device with a user profile, includes a security mechanism configured to secure the entitlement device; a processing element configured to: receive a user input including authentication information; determine the user profile based on the authentication information, and associate the entitlement device with the user profile; and a dispensing portion configured to provide the entitlement device.

Optionally, in some embodiments, the vending device further includes a display area for visually presenting a selection of available entitlement devices.

Optionally, in some embodiments, the selection of available entitlement devices is based on the user profile.

Optionally, in some embodiments, the vending device of further includes a return portion configured to receive a returned entitlement device. The processing element is further configured to disassociate the returned entitlement device from the user profile.

Optionally, in some embodiments, the return portion is configured to provide the returned entitlement device to the security mechanism for securement and further dispensing.

Optionally, in some embodiments, the vending device further includes at least one of a cleaning mechanism configured to clean the returned entitlement device before redistribution or a charger configured to charge the returned entitlement device before redistribution.

Optionally, in some embodiments, the entitlement device is configured to be sensed by an access system, and the access system is configured to provide user access based on the user profile and the sensing of the entitlement device.

Optionally, in some embodiments, the security mechanism includes a secure cabinet.

In one embodiment, a method of associating an entitlement device with a user profile, includes: receiving, via a processing element, user authentication information; determining, via the processing element, the user profile based on the authentication information; receiving, via the processing element, a user input selecting an entitlement device; associating, via the processing element, the entitlement device with the user profile; dispensing the entitlement device via a vending device.

Optionally, in some embodiments, the method further includes determining the user profile includes generating, via the processing element, a new user profile based on the authentication information.

Optionally, in some embodiments, the method includes visually presenting a selection of available entitlement devices.

Optionally, in some embodiments, the selection of available entitlement devices is based on the user profile.

Optionally, in some embodiments, the vending device includes a return portion configured to receive a returned entitlement device, and the method further includes receiving the returned entitlement device via the return mechanism, and disassociating, via the processing element, the entitlement device from the user profile.

Optionally, in some embodiments, the vending device further includes a security mechanism configured to the secure the entitlement device or the returned entitlement device, and the return portion is configured to provide the returned entitlement device to the security mechanism for securement and further dispensing.

Optionally, in some embodiments, the vending device further includes at least one of a cleaning mechanism configured to clean the entitlement device or the returned entitlement device or a charger configured to charge the entitlement device or the returned entitlement device, and the method further includes cleaning or charging the entitlement device or the returned entitlement device prior to redistribution.

Optionally, in some embodiments, the method further includes sensing the entitlement device, via an access system; and providing user access, via the access system, based on the user profile and the sensing of the entitlement device.

In one embodiment, a system for associating an entitlement device with a user profile, includes: a vending device including: a security mechanism configured to secure the entitlement device, and a dispensing portion configured to provide the entitlement device to a user; a processing element configured to: receive a user input including authentication information, determine the user profile based on the authentication information, and associate the entitlement device with the user profile.

Optionally, in some embodiments, the vending device further includes a return portion configured to receive a returned entitlement device, wherein the processing element is further configured to disassociate the returned entitlement device from the user profile responsive to receiving the returned entitlement device.

Optionally, in some embodiments, the return portion is configured to provide the returned entitlement device to security mechanism for securement and further dispensing.

Optionally, in some embodiments, the system of further includes at least one of a cleaning mechanism configured to clean the returned entitlement device before redistribution or a charger configured to charge the returned entitlement device before redistribution.

### BRIEF DESCRIPTION OF THE DRAWINGS

FIG. 1 is a simplified schematic of a system for providing an entitlement device to a user.

FIG. 2 illustrates an embodiment of an interactive environment.

FIG. 3 is flowchart of a method of associating an entitlement device with a user profile via the system of FIG. 1.

FIG. 4 is a flowchart of a method of disassociating an entitlement device from a user profile, and recycling or reusing the entitlement device via the system of FIG. 1.

FIG. 5A is an example of a user interface suitable for use by the system of FIG. 1, prompting a user to scan a credential.

FIG. 5B is an example of a user interface suitable for use by the system of FIG. 1, providing options related to an entitlement device.

FIG. 5C is an example of a user interface suitable for use by the system of FIG. 1, displaying entitlements devices for selection.

FIG. 5D is an example of a user interface suitable for use by the system of FIG. 1, prompting a user to select a payment method.

FIG. 5E is an example of a user interface suitable for use by the system of FIG. 1, prompting a user to retrieve an entitlement device.

FIG. 6 is a simplified block diagram of components of a computing system of the system of FIG. 1.

### DETAILED DESCRIPTION

The systems and methods disclosed provide for automated delivery, management, reuse, and association of entitlement devices with a user. In many embodiments, the system includes an automated vending device that can contain and dispense a variety of entitlement devices to a user. In many embodiments, the vending device includes a security mechanism configured to secure or contain one or more entitlement devices ready to be associated with a user profile and provided to the user. For example, the vending device may include an enclosure that houses the entitlement devices, or a rack or track that restricts unauthorized access to the entitlement devices. The vending device includes a user input that enables the vending device to authenticate a user identity. The vending device may be in communication with a network, and may retrieve a user profile from a database after authenticating a user. In some embodiments, the vending device receives a user preference for one or more entitlement devices and associates the chosen one or more entitlement devices with the user profile. The vending device supplies the entitlement devices to the user. In some embodiments, the vending device receives one or more used entitlement devices from the user. The vending device can dis-associate the used entitlement devices from the user profile. The vending device can re-use, re-cycle, or otherwise re-purpose the used entitlement devices. For example, the vending device may, after dis-associating a used entitlement device from a user profile, place the used entitlement device in its inventory of entitlement devices, which may be associated with, and deployed to, other users.

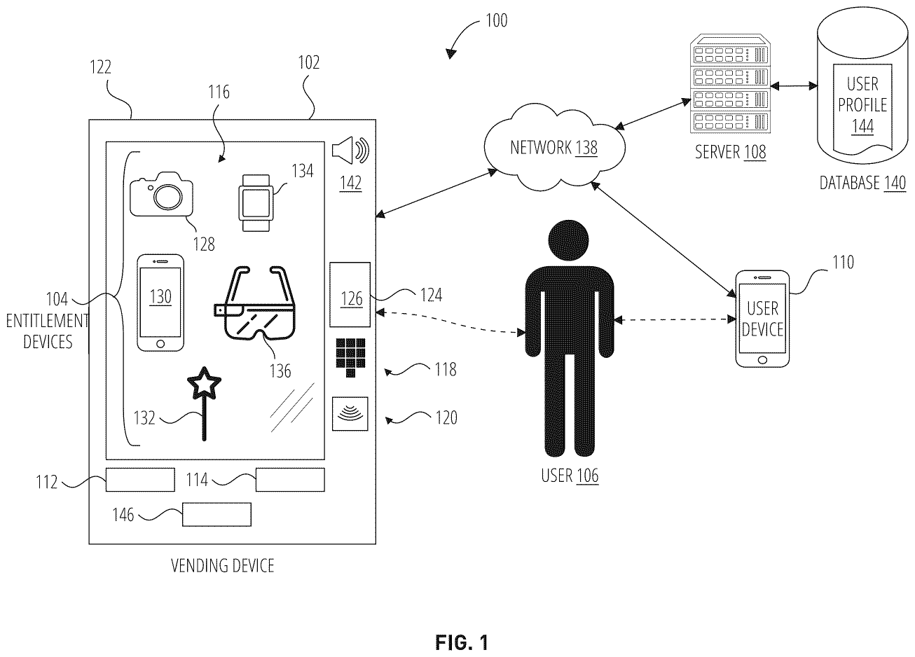

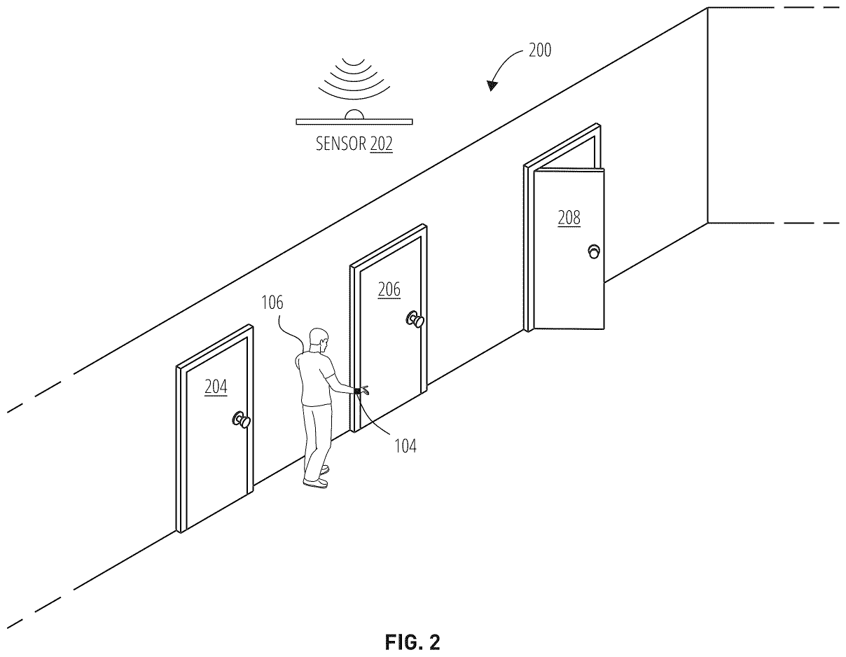

Turning to the figures, FIG. 1 is a schematic of an example of a system 100 for automatically distributing and managing entitlement devices 104. As used herein, an entitlement device is any device that can be associated with a user profile 144, and whose presence or proximity can be sensed by an access system to enable user access to a location, entertainment, transaction completion, etc. (see, e.g., FIG. 2 and related description of an access system 200). An access system controls and provides or denies a user 106 access to locations, features, entertainment, etc. An entitlement device may be an active device with wired or wireless communication capability that enables the entitlement device 104 to communicate with the access system 200. An entitlement device 104 may alternatively or additionally be a passive device that includes an optical mark, shape, color, pattern, etc. (either human or machine visible, such as bar code or QR code) that enables the access system 200 to recognize the entitlement device 104 and provide user 106 access according to the user profile 144.

As shown for example in FIG. 1, the system 100 may include entitlement devices 104 like a camera 128, a smart device 130, a toy 132, a watch 134, and/or a headset 136. Other examples of entitlement devices 104 may include jewelry like necklaces, earrings, rings, etc. Entitlement devices 104 may be articles of clothing like shirts, belts, outerwear, hats, shoes, etc. Entitlement devices 104 may be one or more of a fob, a keychain, a pin, a smart (e.g., radio frequency identification (RFID) or near field communication (NFC)) card, connected device (e.g., a device that communicates with a network 138 or other devices), an internet of things (IoT) device and/or combinations of these. In some embodiments, entitlement devices 104 may be assistive devices that help users 106 with special physical needs, such as assistive listening or physical devices like headphones, strollers, wheelchairs, walkers, walking canes, powered scooters, or the like.

The system 100 includes a vending device 102 that contains, distributes, and can receive entitlement devices 104. The system 100 may include a network 138 by which the vending device 102 and/or entitlement devices 104 communicate with other portions of the system 100, such as a server 108. The network 138 may be a wired network (e.g., Ethernet) a wireless network (e.g., Wi-Fi, Bluetooth, Wi-Max, Zigbee, long range radio (LORA), etc.) and/or combinations of these and other networking technologies. The system 100 may include, or be in communication with, a database 140 that stores user profile data associated with a user 106. The user 106 may optionally have a user device 110 that communicates with the system 100.

The vending device 102 may include an enclosure or security mechanism 122 suitable to contain or control availability of a number of entitlement devices 104. The entitlement devices 104 stored in the vending device 102 may be all the same type, or may be two or more different types of entitlement devices 104, as shown for example in FIG. 1. The enclosure may be a secure cabinet or other device that prevents or reduces vandalism or unauthorized access to the entitlement devices 104. In some embodiments, the vending device 102 controls availability of the entitlement devices 104 through an external mechanism such as a locking rack, such as in cases where the entitlement device 104 is too large to be received in an enclosure 122 (e.g., where the entitlement device 104 is a powered scooter).

The vending device 102 may include a display area 116 such as a transparent panel, electronic display, or the like that reveals the entitlement devices 104 (or representations of entitlement devices 104) contained in or distributable by the vending device 102.

The vending device 102 includes a dispensing portion 112 suitable to dispense a chosen entitlement device 104 to a user 106. The dispensing portion 112 is a mechanism that moves an entitlement device 104 from the security mechanism or enclosure 122 to a location where the user 106 can retrieve the entitlement device. In some embodiments, the dispensing portion may be a claw that grabs the entitlement device 104 from inventory, a lead screw that pushes the entitlement device 104 to a location accessible by the user 106, a door or lock that unlocks and allows the user 106 to access the entitlement device 104, etc. The vending device 102 may also include a return portion 114 suitable to receive a used entitlement device 104 from a user 106. The return portion 114 may be a similar mechanism as the dispensing portion, but adapted to move the entitlement device 104 from a user 106 to the inventory of the vending device 102, and may place the entitlement device within the security mechanism or otherwise secure the entitlement device 104. In some embodiments, the dispensing portion 112 and return portion 114 may be the same portion.

The vending device 102 may include a display 124 that provides a visual user interface 126 to the user 106. The display 124 may include a light emitting diode (LED) or liquid crystal display (LCD) suitable to display a user interface 126. The user interface 126 enables a user 106 to interact with the vending device 102 and the system 100. The vending device 102 may include an input 118 such as a keypad suitable for receiving an input from the user 106. In some embodiments, the input 118 is combined with the display 124, such as in a resistive or capacitive touch screen.

The vending device 102 may include a sensor 120 such as an optical sensor, depth sensor, magnetic sensor, radio frequency identification (RFID), near field communication (NFC) device or the like suitable for receiving user data or inputs. For example, the sensor 120 may be an NFC scanner capable of communication with a user device 110 the user 106 already has. In another example, the sensor 120 may optically recognize a user 106 credential such as a driver's license, bank card, or the like. In another example still, the sensor 120 may recognize a user 106 directly.

The vending device 102 may also include an audio interface 142 suitable to provide auditory outputs to a user 106 and/or receive auditory inputs from a user 106. For example, the audio interface 142 may include a speaker capable of playing or reading-aloud instructions. The auditory output may reflect or describe outputs displayed on the display 124 via the user interface 126. The auditory outputs and/or the user interface 126 may be in any language. Additionally, or alternately, the audio interface 142 may include a sound sensor (e.g., a microphone) capable of receiving spoken or other sound-based inputs from the user 106. The vending device 102 may process such inputs via a speech recognition algorithm or system.

In some embodiments, the user 106 may have a user device 110 such as a smart phone, tablet, laptop, fitness band, watch, or the like. The user device 110 may communicate with the system 100 such that the user device 110 can provide all or a portion of the user interface 126 of the vending device 102 and may control the vending device 102.

FIG. 2 shows an example of a user 106 interacting with an access system 200 via the entitlement device 104. In this example, the access system 200 includes several doors 204, 206, and 208 that the user 106 may, or may not, be able to open, depending on the user profile 144 associated with the entitlement device 104. For example, the access system 200 includes a sensor 202 that detects the entitlement device 104. The sensor 202 may be a proximity sensor, RFID, NFC, optical sensor, auditory sensor, other wired or wireless sensor, etc. adapted to detect or communicate with the entitlement device 104. In the example shown in FIG. 2, the access system 200 reads the entitlement device 104 via the sensor 202. The user profile 144 indicates that the user 106 has access to the door 208 and the access system 200 unlocks or opens the door 208 when the user 106 is nearby. In the example shown, the user profile 144 indicates the user 106 does not have access to the door 204 or the door 206 and those doors remain locked/closed.

In other examples, an access system 200 may provide an entertainment experience to a user 106 based on the user profile 144 associated with the entitlement device 104. For example, a screen controlled by or associated with the access system 200 may play an animation based on the user profile 144 associated with the entitlement device 104 when the entitlement device 104 is detected.

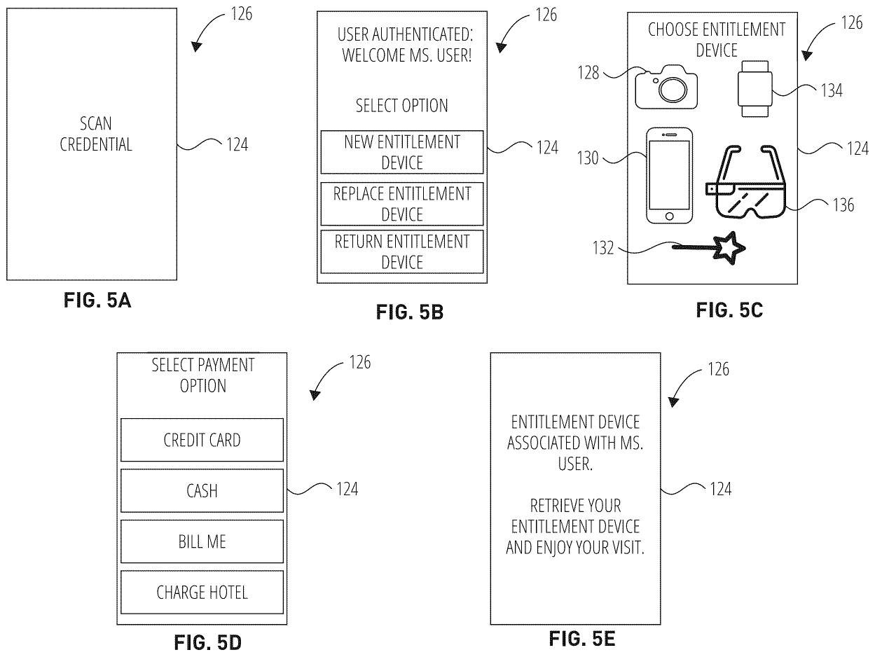

In some examples, the access system 200 may complete a transaction based on the detection of the entitlement device 104. For example, the access system 200 may complete a transaction based on a payment method selected by the user 106. In one example, the access system 200 may detect the presence of the entitlement device 104 and may provide access, entertainment, purchase of an object or service, etc. based on a payment from the user 106. See, e.g., discussion of method 300 and FIG. 5D.

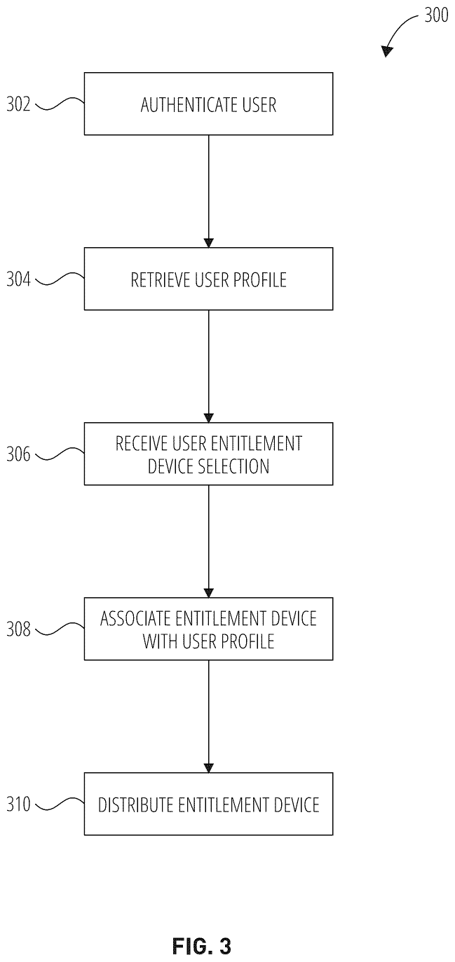

FIG. 3 illustrates an example of a method 300 for associating an entitlement device 104 with a user profile 144 of a user 106 by the system 100. Reference is also made to FIG. 5A-FIG. 5E illustrating examples of a user interface 126 that may be presented by the vending device 102 according to various operations of the method 300. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some examples, the method 300 includes authenticating a user 106 at operation 302. The system 100 may, for example, receive from the user 106, certain user authentication information, such as a name, username, account number, e-mail address, phone number, password, pin number (or other security or access code), etc. For example, the vending device 102 may read or scan a user 106 credential such as a driver's license, identification card, bank card, user device 110, or the like associated with the user 106. In cases where the user device 110 communicates with the system 100, the user device 110 and its associated systems and methods may authenticate the user 106 and transmit the user profile 144 to the system 100. Alternately or additionally, in cases where the user 106 already has a user profile 144 associated with an entitlement device 104, the vending device 102 may scan or communicate with the entitlement device 104 to authenticate the user 106. See also, FIG. 5A showing an example of a user interface 126 on display 124 prompting a user 106 to present a credential for scanning by the vending device 102.

According to some examples, the method 300 includes retrieving a user profile 144 at operation 304. For example, the system 100 may transmit user authentication information received or generated in operation 302 to the server 108 or another device and look up the user authentication information in the database 140. If a user profile 144 is found for the user 106, the system 100 may retrieve at least a portion the user profile 144 from the database 140. If a user profile 144 is not found, the system 100 may prompt the user 106 for different or additional authentication information, or may prompt the user to create a new user profile 144 via the system 100.

According to some examples, the method 300 includes receiving a user entitlement device selection at operation 306. In the operation 306, if a user profile 144 is found or created in the operation 304, the vending device 102 may prompt the user 106 to make a selection of an action the user 106 wishes to complete with the system 100. For example, the vending device 102 may prompt the user 106 via the user interface 126 whether the user 106 wishes to acquire a new entitlement device 104, replace a lost, stolen, or inoperative entitlement device 104, or return an entitlement device 104 that is no longer needed or desired, for reuse or recycling, etc. See, e.g., FIG. 5B showing an example of the user interface 126 on display 124 prompting user 106 for inputs according to the operation 304. In operation 306, or another operation of the method 300, the vending device 102 may prompt a user 106 to pay for the selected entitlement device 104, and/or to select a method of payment to be used for transactions initiated by or related to the entitlement device. For example, the user interface 126 may provide a selection of payment options and the vending device 102 may guide the user 106 through a transaction related to the entitlement device 104. See, e.g., FIG. 5E.

In the operation 304, if the user 106 indicates that they wish to acquire a new entitlement device 104, the operation 304 may proceed and the system 100 presents one or more options of entitlement devices 104 available to the user 106. The availability of specific entitlement devices 104 may be based on the user profile 144, physical availability of certain entitlement devices 104 dispensable by the vending device 102, etc. See, e.g., FIG. 5C showing an example of the user interface 126 on the display 124 of the vending device 102 displaying the options of a camera 128, smart device 130, toy 132, watch 134, or headset 136 for selection by the user 106.

According to some examples, the method 300 includes associating the chosen entitlement device 104 with the user's 106 user profile 144 at operation 308. In some embodiments, the system 100 may communicate with the entitlement device 104 to change a setting or other characteristic of the entitlement device 104 to associate the entitlement device 104 with the user profile 144 of the user 106. For example, the system 100 may, via the vending device 102, program memory on the entitlement device 104 to associate the entitlement device 104 with the user profile 144. In some embodiments, the system 100 may update a record in the database 140 that associates the entitlement device 104 with the user profile 144. In some embodiments, the entitlement device 104 may include an identifier such as a unique identifier associated with the entitlement device 104. The system 100 may read the identifier of the entitlement device (e.g., electronically, wirelessly, optically, etc.) and may associate the identifier of the entitlement device 104 with the user profile 144. When the access system 200 detects the presence or proximity of an entitlement device 104, the access system 200 may either communicate with the entitlement device 104 to determine a user's 106 access privileges, or may communicate with the database 140 to look up the association of the user 106 with the detected entitlement device 104 to determine a user's 106 access privileges. In some embodiments of the operation 308, e.g., if the user already has an entitlement device 104 associated with their user profile 144, the system 100 may associate an additional entitlement device with the user profile 144.

According to some examples, the method 300 includes distributing, delivering, or otherwise making the entitlement device 104 available to the user 106 at operation 310. For example, in the case of an entitlement device 104 that can be stored within an enclosure 122 of the vending device 102, the vending device 102 may through an internal delivery mechanism place the entitlement device 104 in the dispensing portion 112 of the vending device 102 where the entitlement device 104 can be retrieved by the user 106. In examples where the entitlement device 104 is too large or bulky to be received in an enclosure 122, the vending device 102 may unlock or otherwise deliver the entitlement device 104 to the user 106. See, e.g., FIG. 5E showing an example of a user interface 126 on a display 124 of the vending device 102 prompting a user 106 to retrieve the entitlement device 104 associated with the user profile 144 of the user 106. For example, where the entitlement device 104 is a powered scooter, the vending device 102 or another portion of the system 100 may communicate with the scooter to unlock its wheels and steering mechanism or otherwise prepare itself to be driven by the user 106. In some embodiments, the operation 310 may be optional. For example, if the user 106 already has an entitlement device 104 in their possession (e.g., it was given as a gift, was a previously dis-associated entitlement device they did not return, the user 106 is switching entitlement devices 104 with other another user 106 etc.) the system 100 may associate the entitlement device 104 with the user in operation 308 and the method 300 may end.

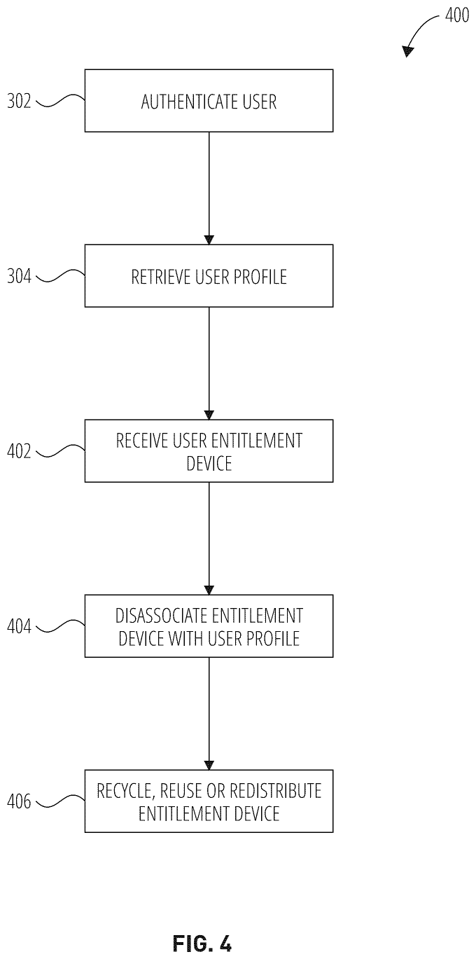

FIG. 4 illustrates an example method 400 for disassociating an entitlement device 104 from a user profile 144, and/or recycling or reusing the entitlement device 104 via the system 100. The system 100 may execute the method 400 when a user 106 wishes to return an entitlement device 104 to the system 100. Examples of such situations may include, but not be limited to: when a user 106 no longer needs or wishes to have the entitlement device 104, an entitlement device 104 is defective and a new entitlement device 104 is desired, the user 106 wishes to try a different entitlement device 104 (such as trading a camera 128 for a toy 132), a user 106 found an entitlement device 104 and wishes to dispose of it in a secure manner, etc.

In cases where the user 106 wishes to swap out an entitlement device 104 for a different entitlement device 104, the system 100 may execute both the method 400 (e.g., to receive the undesired or defective entitlement device 104) and may execute the method 300 (e.g., to supply a new entitlement device 104 to the user 106). In such cases, the system 100 may perform the operations 302 and operation 304 only once each. Such execution of the methods 300 and method 400 may be combined seamlessly from a point of view of the user 106.

Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some examples, the method 400 includes operations 302 and 304 as described with respect to the method 300 for authenticating the user 106 and retrieving the user profile 144, respectively. Further description of the operation 302 and 304 are omitted for brevity and reference is made to the description of the method 300 for relevant details.

According to some examples, the method 400 includes operation 402 in which the vending device 102 receives the entitlement device 104. For example, the user interface 126 of the vending device 102 may prompt the user 106 to place the entitlement device 104 in the return portion 114. After receipt of the entitlement device 104 in the return portion 114, the vending device 102 may move the entitlement device 104 to a secure location within the enclosure of the vending device 102. In examples where the entitlement device 104 is not suitable for storage in the vending device 102, such as the powered scooter example described with respect to the method 300, the system 100 may communicate with the entitlement device 104 to lock or otherwise disable it from further use. For example, the system 100 may cause a wheel, steering, display, user control, and or drive mechanism of the entitlement device 104 to lock or stop operating. In other examples, the system 100 may include a track or rack that receives a portion of the entitlement device 104 (e.g., a wheel, a frame portion, etc.) and physically prevents removal of the entitlement device 104 via a locking mechanism separate from the entitlement device 104.

According to some examples, the method 400 includes disassociating the entitlement device 104 from the user profile 144 at operation 404. In some embodiments, the system 100 may communicate with the entitlement device 104 to change a setting or other characteristic of the entitlement device 104 to disassociate the entitlement device 104 from the user profile 144 of the user 106. For example, the system 100 may, via the vending device 102, program memory on the entitlement device 104 to disassociate the entitlement device 104 from the user profile 144. In some embodiments, the system 100 may update or remove a record in the database 140 that associates the entitlement device 104 with the user profile 144, thereby revoking the user 106 access privileges in the access system 200. When the access system 200 detects the presence or proximity of an entitlement device 104 not associated with or disassociated from the user profile 144, the access system 200 may either communicate directly with the entitlement device 104 or may communicate with the database 140 to look up the association of the user profile 144 of the user 106 with the detected entitlement device 104 to determine that a user's 106 access privileges have been revoked or are otherwise not authorized.

According to some examples, the method 400 optionally includes recycling, reusing and/or redistributing the entitlement device 104 at operation 406. For example, the vending device 102 may, after disassociating the entitlement device 104 from the user profile 144 in operation 404, return the entitlement device 104 to a storage area within the enclosure 122, ready to be re-used and associated with a new user 106. In some embodiments, the vending device 102 may include a cleaning or sanitizing mechanism 146 to clean the entitlement device 104 before it is deployed to a new user 106. The cleaning mechanism may include a sanitizing light (e.g., an ultraviolet light) configured to deactivate microbes on the entitlement device 104, a spray or bath of a sanitizing solution through which the entitlement device 104 passes, a brush to remove solids from the entitlement device 104, a dryer, and/or combinations of these and other devices. In some embodiments, the vending device 102 may include a charger to charge an internal battery or other energy storage device in the entitlement device 104. In some embodiments, the vending device 102 may collect returned entitlement devices 104 in a bin, container, or compartment for further processing by another part of the system 100, manual disposal, recycling or other processing.

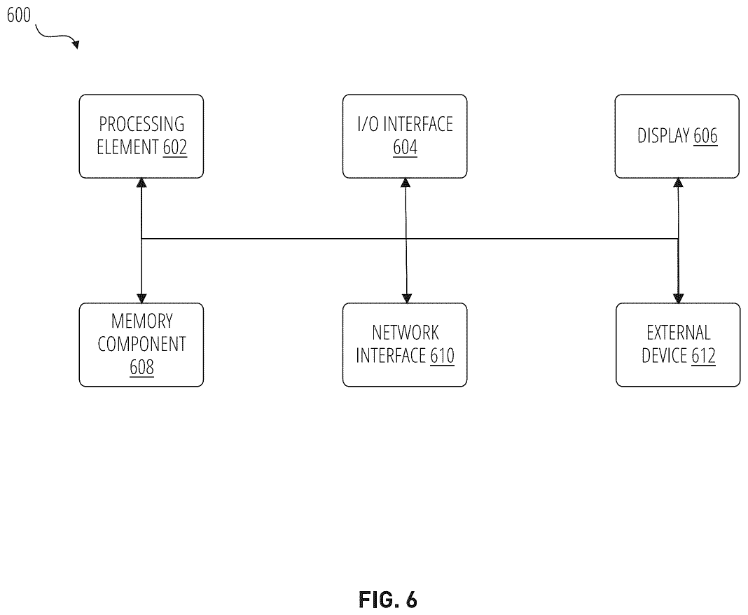

FIG. 6 is a simplified block diagram of components of a computing system 600 of the system 100, such as an entitlement device 104 (e.g., a camera 128, smart device 130, toy 132, watch 134, and/or headset 136, etc.), the user device 110, the server 108, the vending device 102, etc. A computing system 600 may include one or more processing elements 602, an input/output I/O interface 604, a display 606, one or more external devices 612, one or more memory components 608, and a network interface 610. Each of the various components may be in communication with one another through one or more buses or communication networks, such as wired or wireless networks, e.g., the network 138. The components in FIG. 6 are exemplary only. In various examples, the computing system 600 may include additional components and/or functionality not shown in FIG. 6.

The processing element 602 may be any type of electronic device capable of processing, receiving, and/or transmitting instructions. For example, the processing element 602 may be a central processing unit, microprocessor, processor, or microcontroller. Additionally, it should be noted that some components of the computing system 600 may be controlled by a first processing element 602 and other components may be controlled by a second processing element 602, where the first and second processing elements may or may not be in communication with each other.

The I/O interface 604 allows a user to enter data in to computing system 600, as well as provides an input/output for the computing system 600 to communicate with other devices or services. The I/O interface 604 can include one or more input buttons, touch pads, touch screens, and so on.

The external device 612 includes one or more devices that can be used to provide various inputs to the computing systems 600, e.g., mouse, microphone, keyboard, trackpad, sensing element (e.g., a thermistor, humidity sensor, light detector, etc. The external devices 612 may be local or remote and may vary as desired. In some examples, the external devices 612 may also include one or more additional sensors.

The memory components 608 are used by the computing system 600 to store instructions for the processing element 602 such as for executing the methods disclosed herein, such as the method 300 and/or method 400, the user interface 126, all or a portion of the database 140, user profile 144, as well as store data, user preferences, alerts, access privileges, etc. The memory components 608 may be, for example, magneto-optical storage, read-only memory, random access memory, erasable programmable memory, flash memory, or a combination of one or more types of memory components.

The network interface 610 provides communication to and from the computing system 600 to other devices. The network interface 610 includes one or more communication protocols, such as, but not limited to Wi-Fi, Wi-Max, Zigbee, long range (LORA) radio, Ethernet, Bluetooth, etc. The network interface 610 may also include one or more hardwired components, such as a Universal Serial Bus (USB) cable, or the like. The configuration of the network interface 610 depends on the types of communication desired and may be modified to communicate via Wi-Fi, Bluetooth, etc.

The display 606 provides a visual output for the computing system 600 and may be varied as needed based on the device. For example, the display 606 may be the same display as the display 124 or a different display. The display 606 may be configured to provide visual feedback to the user 106 and may include an LCD screen, LED screen, plasma screen, or the like. In some examples, the display 606 may be configured to act as an input 118 element for the user 106 through touch feedback or the like.

The processing element 602 and the memory component 608 may be located at one or in several computing systems 600. This disclosure contemplates any suitable number of such computing systems 600. For example, the server 108 may be a desktop computing system, a mainframe, a blade, a mesh of computing systems 600, a laptop or notebook computing system 600, a tablet computing system 600, an embedded computing system 600, a system-on-chip, a single-board computing system 600, or a combination of two or more of these. Where appropriate, a computing system 600 may include one or more computing systems 600; be unitary or distributed; span multiple locations; span multiple machines; span multiple data centers; or reside in a cloud, which may include one or more cloud components in one or more networks.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

All relative, directional, and ordinal references (including top, bottom, side, front, rear, first, second, third, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A vending device for associating an entitlement device with a user profile, comprising:
a security mechanism configured to secure the entitlement device;
a processing element configured to:
receive a user input including authentication information;
determine the user profile based on the authentication information, and
associate the entitlement device with the user profile; and
a dispensing portion configured to provide the entitlement device.

2. The vending device of claim 1, further comprising a display area for visually presenting a selection of available entitlement devices.

3. The vending device of claim 2, wherein the selection of available entitlement devices is based on the user profile.

4. The vending device of claim 1, further comprising a return portion configured to receive a returned entitlement device, wherein the processing element is further configured to disassociate the returned entitlement device from the user profile.

5. The vending device of claim 4, wherein the return portion is configured to provide the returned entitlement device to the security mechanism for securement and further dispensing.

6. The vending device of claim 4, further comprising at least one of a cleaning mechanism configured to clean the returned entitlement device before redistribution or a charger configured to charge the returned entitlement device before redistribution.

7. The vending device of claim 1, wherein the entitlement device is configured to be sensed by an access system, and the access system is configured to provide user access based on the user profile and the sensing of the entitlement device.

8. The vending device of claim 1, wherein the security mechanism comprises a secure cabinet.

9. A method of associating an entitlement device with a user profile, comprising:
receiving, via a processing element, user authentication information;
determining, via the processing element, the user profile based on the authentication information;
receiving, via the processing element, a user input selecting an entitlement device;
associating, via the processing element, the entitlement device with the user profile;
dispensing the entitlement device via a vending device.

10. The method of claim 9, wherein determining the user profile comprises generating, via the processing element, a new user profile based on the authentication information.

11. The method of claim 9, further comprising visually presenting a selection of available entitlement devices.

12. The method of claim 11, wherein the selection of available entitlement devices is based on the user profile.

13. The method of claim 9, wherein the vending device comprises a return portion configured to receive a returned entitlement device, and the method further comprises:
receiving the returned entitlement device via the return mechanism, and
disassociating, via the processing element, the entitlement device from the user profile.

14. The method of claim 13, wherein the vending device further comprises a security mechanism configured to the secure the entitlement device or the returned entitlement device, and the return portion is configured to provide the returned entitlement device to the security mechanism for securement and further dispensing.

15. The method of claim 13, wherein the vending device further comprises at least one of a cleaning mechanism configured to clean the entitlement device or the returned entitlement device or a charger configured to charge the entitlement device or the returned entitlement device, and the method further comprises cleaning or charging the entitlement device or the returned entitlement device prior to redistribution.

16. The method of claim 9, further comprising:
sensing the entitlement device, via an access system; and
providing user access, via the access system, based on the user profile and the sensing of the entitlement device.

17. A system for associating an entitlement device with a user profile, comprising:
a vending device including:
a security mechanism configured to secure the entitlement device, and
a dispensing portion configured to provide the entitlement device to a user;
a processing element configured to:
receive a user input including authentication information,
determine the user profile based on the authentication information, and
associate the entitlement device with the user profile.

18. The system of claim 17, wherein the vending device further comprises a return portion configured to receive a returned entitlement device, wherein the processing element is further configured to disassociate the returned entitlement device from the user profile responsive to receiving the returned entitlement device.

19. The system of claim 18, wherein the return portion is configured to provide the returned entitlement device to security mechanism for securement and further dispensing.

20. The system of claim 18, further comprising at least one of a cleaning mechanism configured to clean the returned entitlement device before redistribution or a charger configured to charge the returned entitlement device before redistribution.
